(19) United States
(12) Patent Application Publication
(10) Pub. No.: US 2019/0345759 A1
(43) Pub. Date: Nov. 14, 2019

(54) Dropdown Flood Barrier

(71) Applicant: Parafoil Design & Engineering Pte Ltd, Singapore (SG)

(72) Inventor: Jwee Thiam Quek, Singapore (SG)

(21) Appl. No.: 16/469,443

(22) PCT Filed: Dec. 22, 2016
(86) PCT No.: PCT/SG2016/050612

§ 371 Date: Jun. 13, 2019

(51) Int. Cl. E06B 9/04; E02B 7/28; E06B 7/23; E02B 7/54

(52) U.S. Cl. CPC E06B 9/04; E02B 7/28; E06B 2009/007; E06B 7/2314; E02B 7/54; E06B 7/2309

(57) ABSTRACT

A dropdown flood barrier (100) is disclosed, which comprises at least one panel (102) and an associated counterweight (104), the panel configured to be movable between an elevated position and a lowered position in cooperation with the counterweight; and at least one rotatable drive (106) coupled to the panel, and is configured such that rotation of the rotatable drive enables the panel to be moved from the elevated position to the lowered position, the rotatable drive includes a brake arranged to exert a force against the rotation of the rotatable drive when a speed of the rotation exceeds a predetermined threshold, wherein in use, the rotatable drive is activated to enable the panel to controllably move under its own weight from the elevated position to the lowered position to form a barrier against flood water, the controllable movement of the panel enabled by the brake of the rotatable drive and the counterweight.

FIELD OF INVENTION

The present invention relates to a dropdown flood barrier.

### BACKGROUND OF THE INVENTION

Climate change increases probability of certain types of weather. For example, more frequent heavy rains and flooding observed in different parts of the world are consistent with a warming planet, and such events are expected to gradually become more common over time, in line with predicted weather forecasting.

As average temperatures in many parts around the world have gone up, more rain has fallen during the heaviest downpours. This is because warmer air holds more moisture, and when the warm air (holding moisture) meets cooler air, the moisture condenses into tiny droplets that float in the air. If the drops accumulate and become heavy enough, they fall as precipitation (i.e. rain). As a consequence of global warming, annual precipitation levels have increased in many regions around the world, but however decreased in others. Hence, some regions experienced prolonged droughts, while others have had intense rainstorms, causing flash floods or even large-scale floods. These precipitation changes, along with temperature shifts, threaten agriculture, and livelihood, as well as cause damage to property and infrastructure, resulting in unimaginable economic losses.

Unfortunately, conventional measures devised to deal with the increase in precipitation have not been particularly effective, in part due to the unpredictability of rainfall patterns brought about by global warming. So, one object of the present invention is therefore to address at least one of the problems of the prior art and/or to provide a choice that is useful in the art.

### SUMMARY OF INVENTION

According to a 1st aspect, there is provided a dropdown flood barrier comprising: at least one panel and an associated counterweight, the panel configured to be movable between an elevated position and a lowered position in cooperation with the counterweight; and at least one rotatable drive coupled to the panel, and is configured such that rotation of the rotatable drive enables the panel to be moved from the elevated position to the lowered position, the rotatable drive includes a brake arranged to exert a force against the rotation of the rotatable drive when a speed of the rotation exceeds a predetermined threshold, wherein in use, the rotatable drive is activated to enable the panel to controllably move under its own weight from the elevated position to the lowered position to form a barrier against flood water, the controllable movement of the panel enabled by the brake of the rotatable drive and the counterweight.

Advantageously, the proposed flood barrier is arranged to be deployed, in the event of a flood, without need and/or use of electrical power supplies since the panel is moved to the lowered position under influence of gravity, but beneficially in a controlled manner with aid of the brake of the rotatable drive, and the counterweight.

Preferably, the panel may be arranged intermediate two member posts.

Preferably, the member posts may be included as part of the flood barrier, which is to be installed across a canal or a river.

Alternatively, the member posts may instead be structural members at an entrance of a building at where the flood barrier is to be installed.

Preferably, the panel may further include a plurality of seals having corrugated surfaces to interface with the member posts to enable the panel to form the barrier against the flood water when in the lowered position.

Preferably, each seal may in a rest condition have a generally D-shaped cross-sectional area.

Preferably, each seal may be a Thermoplastic-Vulcanizers (TPV) Ethylene-Propylene-Diene-Monomer (EPDM) seal.

Preferably, each seal may have an operating temperature range of between −40° C. and 130° C.

Preferably, the plurality of seals may be arranged at edges of the panel.

Preferably, at least two layers of seals may be arranged at each edge of the panel.

Preferably, the at least one panel may include a plurality of panels configured in a cooperative arrangement to collectively form the flood barrier.

Preferably, the panel may be formed from steel structural members.

Preferably, the rotatable drive may be coupled to the panel using a plurality of stainless steel wire ropes.

Preferably, the counterweight may be formed from steel, and is arranged in a tubular configuration.

Yet alternatively, the counterweight may be formed from casted lead ingots, and is arranged in a tubular configuration.

Optionally, the counterweight may be formed from steel, and is arranged in a cage configuration.

Preferably, the flood barrier may further comprise a threshold plate for positioning at the floor of the entrance to interface with the panel when the panel is in the lowered position.

Preferably, the rotatable drive may further comprise at least one electromagnetic lock configured to be electrically activated to inhibit rotation of the rotatable drive to hold the panel in the elevated position, and to be electrically deactivated to permit rotation of the rotatable drive to enable the panel to be moved to the lowered position.

Preferably, the brake may include brake pads arranged to be extendable centrifugally from the main body of the brake to contact against a surface of the rotatable drive for exerting the force, when the speed of the rotation of the rotatable drive exceeds the predetermined threshold.

According to a 2nd aspect, there is provided a method of operating a dropdown flood barrier, which includes at least one panel and an associated counterweight, the panel configured to be movable between an elevated position and a lowered position in cooperation with the counterweight, at least one rotatable drive coupled to the panel, and is configured such that rotation of the rotatable drive enables the panel to be moved from the elevated position to the lowered position, the rotatable drive includes a brake arranged to exert a force against the rotation of the rotatable drive when a speed of the rotation exceeds a predetermined threshold. The method comprises: activating the rotatable drive to enable the panel to controllably move under its own weight from the elevated position to the lowered position to form a barrier against flood water, wherein the controllable movement of the panel is enabled by the brake of the rotatable drive and the counterweight.

It should be apparent that features relating to one aspect of the invention may also be applicable to the other aspects of the invention.

These and other aspects of the invention will be apparent from and elucidated with reference to the embodiments described hereinafter.

### BRIEF DESCRIPTION OF DRAWINGS

Embodiments of the invention are disclosed hereinafter with reference to the accompanying drawings, in which:

FIG. 1a is a front elevation view of a dropdown flood barrier (in an elevated position), according to a first embodiment.

FIG. 1b is a side view of the flood barrier of FIG. 1a.

FIG. 1c is a top view of the flood barrier of FIG. 1a.

FIG. 2a is a front elevation view of the dropdown flood barrier of FIG. 1a, now moved to a lowered position.

FIG. 2b is a side view of the flood barrier of FIG. 2a.

FIG. 2c is a top view of the flood barrier of FIG. 2A.

FIG. 3 is an enlarged view of portion A of FIG. 1b.

FIG. 4 is an enlarged view of portion A of FIG. 2b.

FIG. 5 is an enlarged view of portion B of FIG. 2b.

FIG. 6a is an enlarged view of portion B of FIG. 1c.

FIG. 6b is an enlarged view of portion C of FIG. 1c.

FIG. 7a is an enlarged view of portion D of FIG. 1a.

FIG. 7b is an enlarged view of portion E of FIG. 1a.

FIG. 8a is a front elevation view of a dropdown flood barrier (in an elevated position), according to a second embodiment.

FIG. 8b is a side view of the flood barrier of FIG. 8a.

FIG. 9a is a front elevation view of the dropdown flood barrier of FIG. 8a, now moved to a lowered position.

FIG. 9b is a side view of the flood barrier of FIG. 9a.

FIG. 10 is an enlarged view of portion A of FIG. 9b.

FIG. 11 is an enlarged view of portion B of FIG. 9b.

FIG. 12 is an enlarged view of portion A of FIG. 8b.

FIG. 13 is an enlarged view of portion B of FIG. 8a.

FIG. 14 is a top view of the flood barrier of FIG. 8a.

FIG. 15 is an enlarged view of portion A of FIG. 14.

FIG. 16a is a photograph showing various components of a tubular drive that has been disassembled, whereas FIG. 16b is a photograph of a cross-sectional view of the tubular drive.

### DESCRIPTION OF EMBODIMENTS

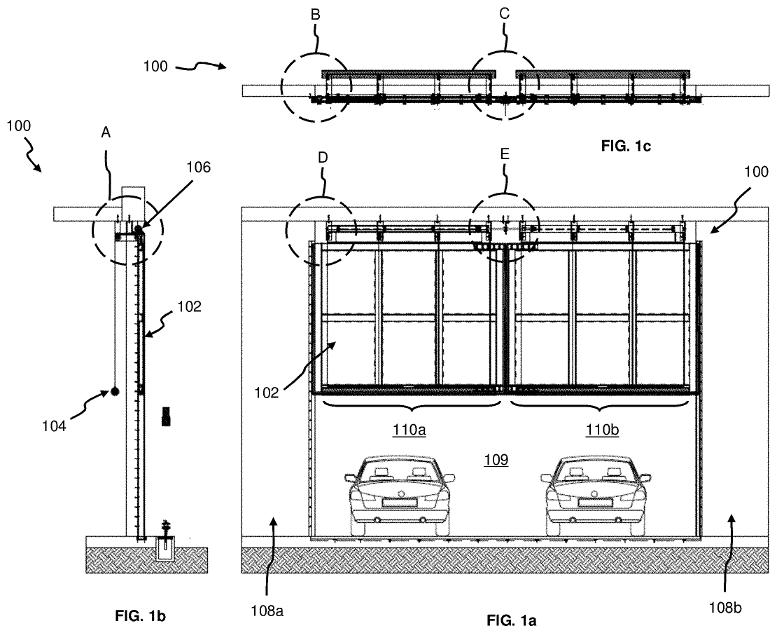

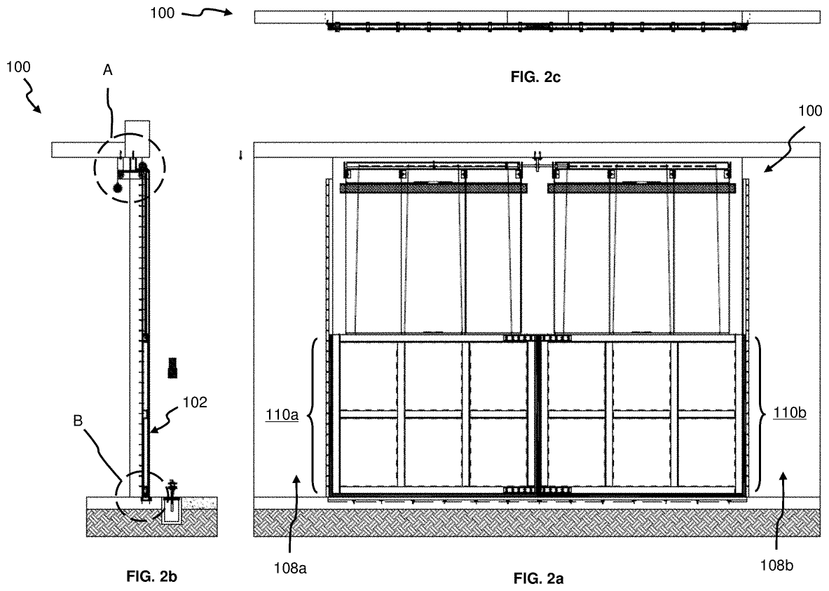

FIGS. 1a, 1b, and 1c respectively show a front elevation view (in an elevated position), a side view, and a top view of a first dropdown flood barrier 100, according to a first embodiment. In connection, FIGS. 2a, 2b, and 2c respectively show a front elevation view, a side view, and a top view of the first flood barrier 100 now moved to a lowered position. Broadly, the first flood barrier 100 comprises: at least one panel 102 and an associated counterweight 104, the panel 102 configured to be movable between an elevated position (i.e. see FIG. 1a) and a lowered position (i.e. see FIG. 2a) in cooperation with the counterweight 104; and at least one rotatable drive 106 coupled to the panel 102, and is configured such that rotation of the rotatable drive 106 enables the panel 102 to be moved from the elevated position to the lowered position, the rotatable drive 106 includes a brake (not shown) arranged to exert a force against the rotation of the rotatable drive 106 when a speed of the rotation exceeds a predetermined threshold. So when the first flood barrier 100 is in use, the rotatable drive 106 is activated to enable the panel 102 to controllably move under its own weight from the elevated position to the lowered position to form a protective barrier against intruding flood water, in which the controllable movement of the panel 102 is enabled by the brake of the rotatable drive 106 and the counterweight 104. In this embodiment, the first flood barrier 100 is to be installed at an entrance 109 of a building, where the panel 102 is specifically arranged intermediate two member posts 108a, 108b. In FIG. 1a, the member posts 108a, 108b are reinforced concrete structural members of the building.

The panel 102, generally rectangular in shape, is formed from steel structural members to better enable the first flood barrier 100 to withstand hydrostatic and hydrodynamic loads imposed by the flood waters. Also, it is to be appreciated in this case (i.e. FIG. 1a) that the definition of the “at least one panel 102” includes two such similar panels 110a, 110b (with respective counterweights 104) cooperatively arranged (side by side) to fully span the width of the entrance 109 of the building in order to be assembled as the barrier to guard against flood water. But this should not be construed as limiting, since more panels 102 may be used as necessary, to adequately cover the width of an entrance at a different locale where the first flood barrier 100 is to be installed.

Accordingly, the definition of the “at least one rotatable drive 106” thus also means that there are at least two rotatable drives, one arranged for each of the panels 110a, 110b.

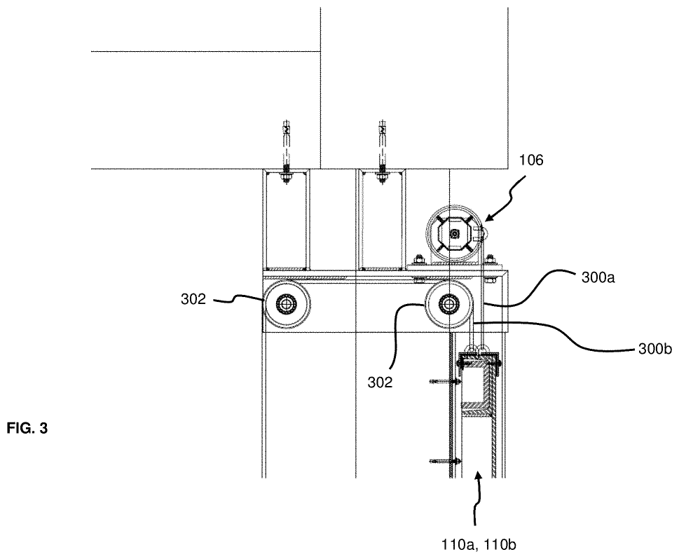

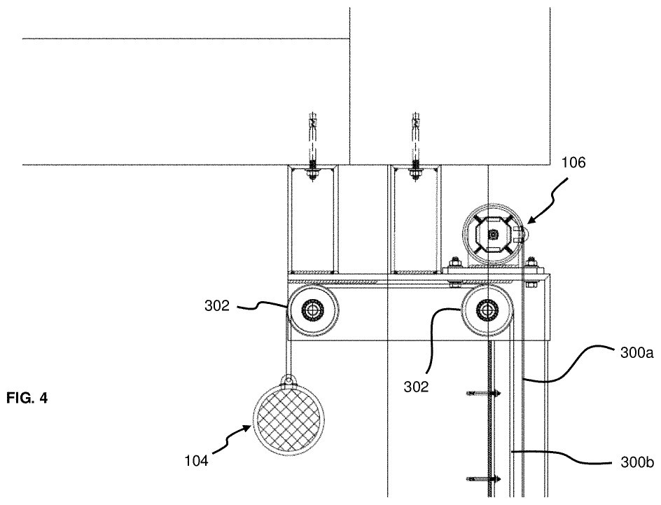

Each rotatable drive 106 is arranged to be coupled to the associated panel 110a, 110b using a plurality of stainless steel wire ropes 300a removably attached to the top lengthwise edge of the associated panel 110a, 110b—see FIG. 3. In turn, the associated counterweight 104 is also coupled to the same top lengthwise edge of the associated panel 110a, 110b using a separate set of plurality of stainless steel wire ropes 300b (which are arranged to be movable on a set of steel pulleys 302 to facilitate movement of the associated panel 110a, 110b between the elevated and lowered positions)—see FIGS. 3 and 4, which are respectively enlarged views of portion A of FIG. 1b and portion A of FIG. 2b. It is to be appreciated that the rotatable drive 106 and steel pulleys 302 are mounted on a supporting platform, which is secured (using steel mounting brackets and masonry anchors) to a wall at the top of the entrance 109. Specifically, the counterweight 104 is purposefully configured and calibrated to balance the weight difference of the associated panel 110a, 110b allowing ease of operating the panel 110a, 110b to be elevated or lowered (be it using mechanical means or manual means). The counterweight 104 may be formed from steel, and is arranged in a tubular configuration (i.e. tubular steel counterweight), or in a cage configuration. Alternatively, the counterweight 104 may also be formed from casted lead ingots, and is also arranged in a tubular configuration (i.e. tubular lead counterweight, which tends to be much heavier than the tubular steel counterweight).

Further, each rotatable drive 106 is implemented as a tubular drive configured to rotate freely with the movement of the associated panel 110a, 110b. The tubular drive is housed in a steel roller tube that enables the stainless steel wire ropes 300a to be coiled or uncoiled (around on the steel roller tube) when the associated panel 110a, 110b is lifted or and lowered. The tubular drive comprises a centrifugal brake configured to exert a force against the rotation of the tubular drive when a speed of the rotation exceeds a predetermined threshold. In an example, the tubular drive further comprises a tubular drive tube, and the centrifugal brake within the tubular drive further comprises brake pads arranged to be extendable outwards (in a centrifugal-like manner) from a main body of the centrifugal brake to contact against a surface of the tubular drive tube. That is, when the speed of rotation of the tubular drive exceeds the predetermined threshold, the brake pads centrifugally extend from the main body of the centrifugal brake, and then correspondingly exert an opposing frictional force against the surface of the tubular drive tube. This slows down the rotational speed of the tubular drive and may even stop the rotation of the tubular drive completely. However, usually in a split second of time after the rotational speed of the tubular drive decreases, the brake pads are retracted via resilient elements attached between the brake pads and the main body of the centrifugal brake. These resilient elements may be springs. This removes the opposing frictional force exerted against the surface of the tubular drive tube and the rotational speed of the tubular drive increases. Importantly, the presence of the centrifugal brake in the tubular drive is advantageous as this helps to limit the speed of rotation of the tubular drive, which consequently limits the speed at which the associated panel 110a, 110b moves due to the coupling between the tubular drive and the associated panel 110a, 110b. So essentially, the centrifugal brake functions as a retarder mechanism to prevent the associated panel 110a, 110b, when moving into the lowered position under its own weight, from speeding out of control, beyond the designated range of incremental acceleration designed for the first dropdown flood barrier 100.

Moreover, the tubular drive is also formed with an integrated locking member, which is configured to be switchable between a locked state (i.e. electrically activated) and an unlocked state (i.e. electrically deactivated). In the locked state, the locking member locks the tubular drive (by stopping rotating movement of the steel roller tube) to inhibit rotation, and thus the associated panel 110a, 110b stays in the elevated position, whereas when the locking member is in the unlocked state, the locking member however permits the tubular drive to rotate and thus the associated panel 110a, 110b controllably moves (aided by the centrifugal brake of the tubular drive and the counterweight 104) from the elevated position to the lowered position under its own weight. Accordingly, to activate the first flood barrier 100, the locking members of all the tubular drives are deactivated i.e. switched from the locked state to the unlocked state. In one example, each locking member is an energized electromagnetic lock (which may be a 24 V DC electromagnet) and is deactivated by disrupting the power supply to the locking member.

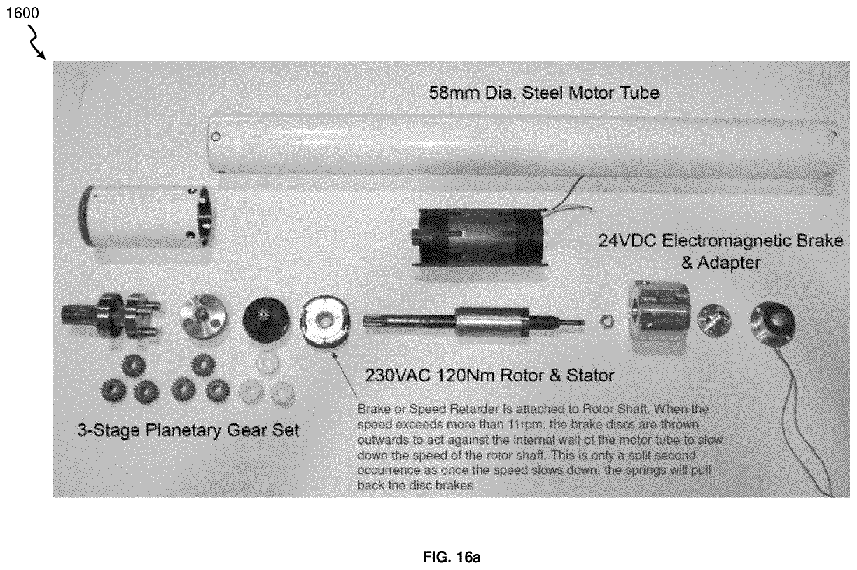

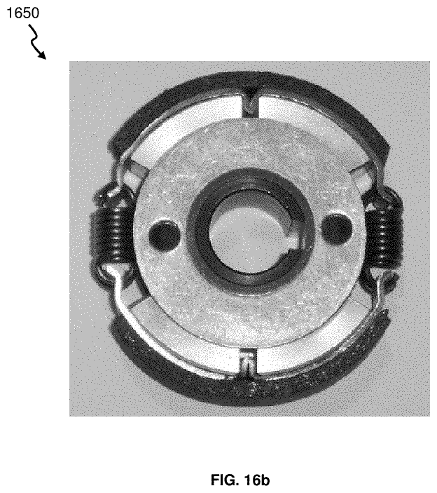

For illustration purpose, FIG. 16a is a photograph 1600 showing various components of the tubular drive that has been disassembled, whereas FIG. 16b is a photograph 1650 of a cross-sectional view of the tubular drive.

As mentioned, each rotatable drive 106 is arranged with the associated panel 110a, 110b such that the panel 110a, 110b moves, with a rotation of the rotatable drive 106, from the elevated position to the lowered position (or vice-versa). In the configuration shown in FIG. 3, the rotatable drives 106 are mounted on the supporting platform, and coupled to the panels 110a, 110b via the stainless steel wire ropes 300a. To deploy the first flood barrier 100, the rotatable drives 106 are switched on by electrically deactivating the locking members of all the rotatable drives 106. This starts the downward movement of the panels 110a, 110b from the elevated position, under influence of their own weight, since the rotatable drives 106 are now permitted to rotate freely but controllably by means of the centrifugal brakes and the counterweights. That is to say, the first flood barrier 100 is specifically devised to be deployed, in the event of a flood, without need and/or use of electrical power supplies (because the locking members are electrically deactivated and) since the panels 110a, 110b are in fact moving downward under influence of gravity. Also, two mechanical limit switches are present in each rotatable drive 106. Each of these switches can be calibrated independently using screws on the respective rotatable drives 106 and serve to stop the rotation of the rotatable drives 106 after the panels 110a, 110b have reached the lowered position. In one example, each rotatable drive 106 is a weatherproof tubular drive which when turned on, has an average internal rotational speed of about 2000 rpm, and an internal gear mechanism to reduce this rotational speed, and thereby rotate an external surface of the drive at a rotational speed of about 11 rpm, the external surface being coupled to the stainless steel wire ropes 300a for moving the panels 110a, 110b. The weight/force in which the rotatable drive 106 is able to pull/support is between 120 kg to 500 kg.

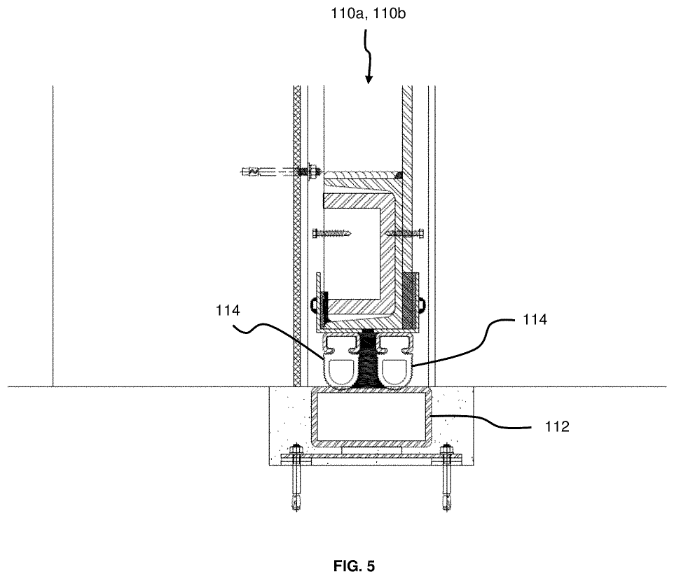

Referring to FIG. 5, which shows an enlarged view of portion B of FIG. 2b, a threshold plate 112 (also known as a base plate) formed of stainless steel, is arranged in a longitudinal recess located in the floor of the entrance 109, and is generally fixed in position using (for example) masonry anchors (i.e. not normally removed unless for maintenance purposes). In position, the threshold plate 112 is level with the floor.

Specifically, the longitudinal recess is located across the width of the entrance 109, and so the threshold plate 112 is configured to extend the full width of the entrance 109, where the first flood barrier 100 is to be deployed.

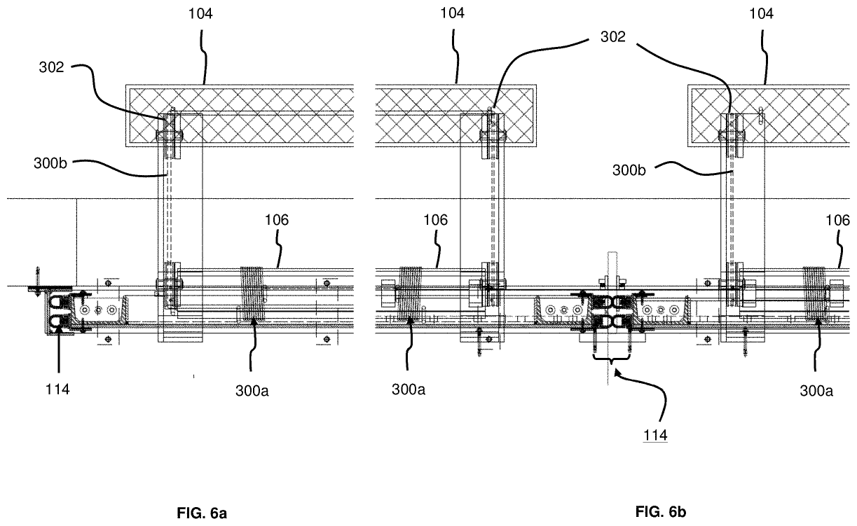

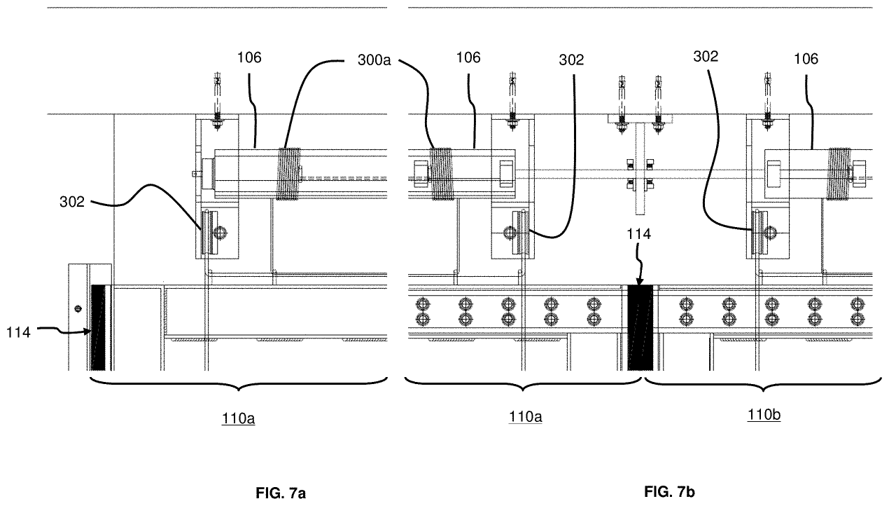

Further, it is to be appreciated that each panel 110a, 110b is lined at its edges with a plurality of seals 114 having corrugated surfaces to interface with the respective member posts 108a, 108b to enable the two panels 110a, 110b to form a water-tight assembly against the flood water when in the lowered position (i.e. see FIGS. 6a and 6b, being respectively enlarged views of portion B of FIG. 1c, and portion C of FIG. 1c). Also, see FIG. 7a, which is an enlarged view of portion D of FIG. 1a, and FIG. 7b, which is an enlarged view of portion E of FIG. 1a. The seals 114 are substantially longitudinal in configuration, and can be easily removed from the edges if necessary for maintenance. In a rest condition, the seals 114 are arranged to have a generally D-shaped cross-sectional area, and the corrugated surfaces are specifically configured to function as a plurality of barriers (acting against ingress of flood waters) in comparison to flat surfaces. Conventional seals with flat surfaces have only a single sealing face, which may be distorted or corrupted with usage overtime to undesirably allow ingress of waters. In contrast, the corrugated surfaces beneficially provide multiple layers of barriers (to the flood waters) when being exerted against the contact surfaces of the member posts 108a, 108b or the threshold plate 112. Further, the D-shaped cross-sectional area of the seals 114 are advantageous when the seals 114 are compressed into tight corners of the member posts 108a, 108b that interface with the threshold plate 112 to prevent entry of flood waters. It is also to be appreciated that when pressure of the flood waters push against the two panels 110a, 110b, the seals 114 then resiliently exert on the contact surfaces of the member posts 108a, 108b resulting in an even tighter sealing with the member posts 108a, 108b. Moreover, the corrugated surfaces also help to reduce friction when the panels 110a, 110b are moved from the elevated position to the lowered position (or vice-versa). Thus, the corrugated surfaces enable a better degree of sealing for a given amount of frictional force imposed.

Particularly, there are at least two layers of seals 114 arranged in parallel at each edge of the associated panel 110a, 110b, and the seals 114 are configured to act against the contact surfaces of the member posts 108a, 108b to form a water-tight arrangement to effectively protect against ingress of flood waters into the entrance 109. The seals 114 used in this embodiment are Thermoplastic-Vulcanizers (TPV) type Ethylene-Propylene-Diene-Monomer (EPDM) seals (which has an operating temperature range of between −40° C. and 130° C.), but not to be construed as limiting since other suitable seals may be used. The TPV-type EPDM seals are adopted for their strong resistance against UV rays/Ozone, as the first flood barrier 100 can also be deployed in outdoor environments. It is also to be appreciated that the seals 114 are not to be made of neoprene and/or any other water resistant membrane that are unable to withstand harsh environmental elements.

The first flood barrier 100 is configured such that it is activated (i.e. the panels 110a, 110b moved to the lowered position) in response to a signal from a sensor for sensing an imminent flood and deactivated using a key switch control or a reset button at a control panel. The sensor may work by detecting the level of water above the ground in which the first flood barrier 100 is installed. Alternatively, the first flood barrier 100 may be manually activated by deactivating the locking members using a key switch control or a push button. The first flood barrier 100 may also be activated by manually and gradually lowering the panels 110a, 110b against the force exerted by the locking members. Once the flood has receded, the panels 110a, 110b are lifted back to the elevated position using electrical motors (e.g. via a winding/pulley mechanism, utilising mechanical advantage presented by a difference in weight between the panels 110a, 110b and associated counterweights 104) arranged together with the first flood barrier 100. Optionally, the panels 110a, 110b may be moved back to the elevated position manually if desired, without using the electrical motors.

In addition, the first flood barrier 100 is coupled to a battery backup system (for example a UPS system) for power redundancy purposes. This serves to provide backup power to the first flood barrier 100 in the event of a power failure (failure of the mains in-coming power supply) which may deactivate the locking members causing the panels 110a, 110b to be deployed inadvertently (i.e. moved from the elevated position to the lowered position even in absence of an imminent flood). The battery backup system may be selected to provide backup power for 1 hour, 2 hours, 4 hours, 8 hours or any other number of hours depending on user's requirements. The locking members are configured such that in the event that the first flood barrier 100 is activated when the battery backup system is being used, the locking members will still be deactivated. The first flood barrier 100 may be further coupled to a drainage system to drain any water that enters the interior of the first flood barrier 100.

So in its broadest definition, a method of operating the first flood barrier 100 simply comprises activating the rotatable drive 106 to enable the at least one panel 102 to controllably move under its own weight from the elevated position to the lowered position to form a barrier against flood water, where the controllable movement of the panel 102 is enabled by the brake of the rotatable drive 106 and the counterweight 104.

The remaining configurations will be described hereinafter. For the sake of brevity, description of like elements, functionalities and operations that are common between the different configurations are not repeated; reference will instead be made to similar parts of the relevant configuration(s).

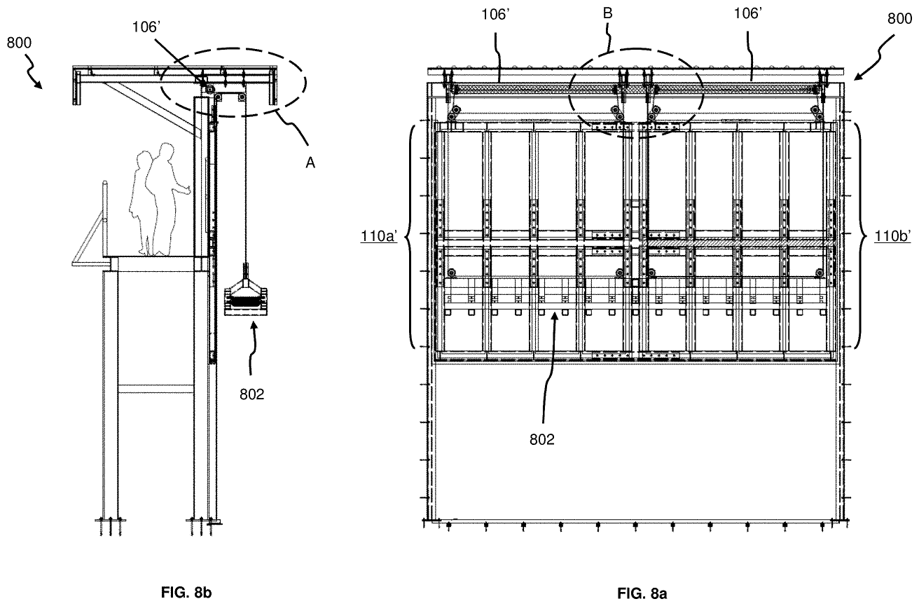

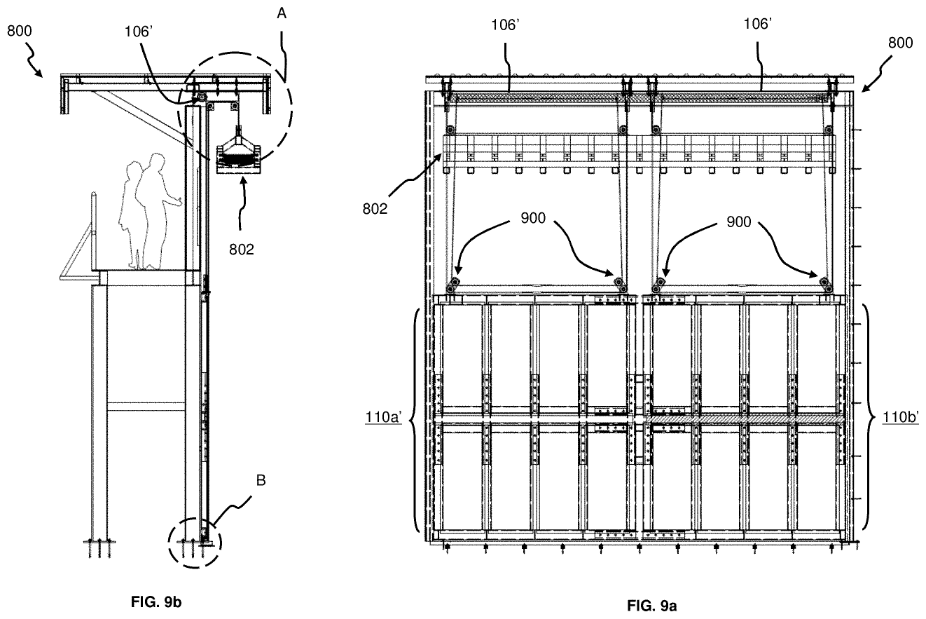

FIGS. 8a, and 8b respectively show a front elevation view (in an elevated position), and a side view of a second dropdown flood barrier 800, according to a second embodiment. Then, FIGS. 9a, and 9b respectively show a front elevation view, and a side view of the second flood barrier 800 now moved to a lowered position. It is highlighted that the second flood barrier 800 is largely similar to the first flood barrier 100 and so the same parts will have the same reference numerals with the addition of prime. The method of operating the second flood barrier 800 (for deployment to protect against intruding flood waters) is also same as that for the first flood barrier 100, and will not be repeated.

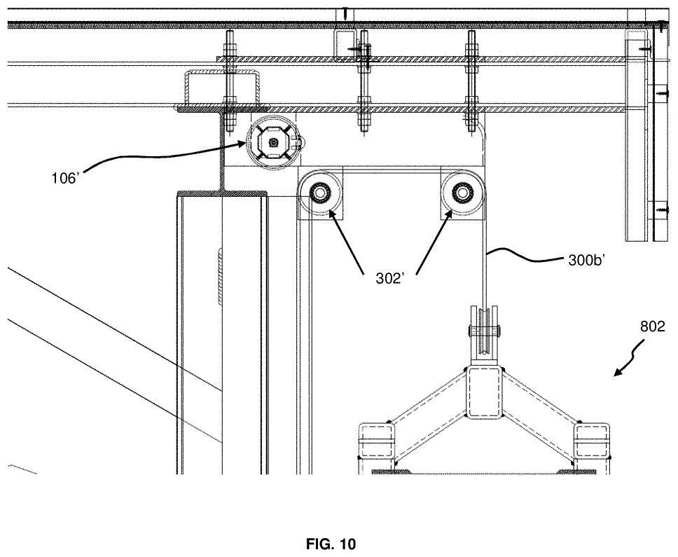

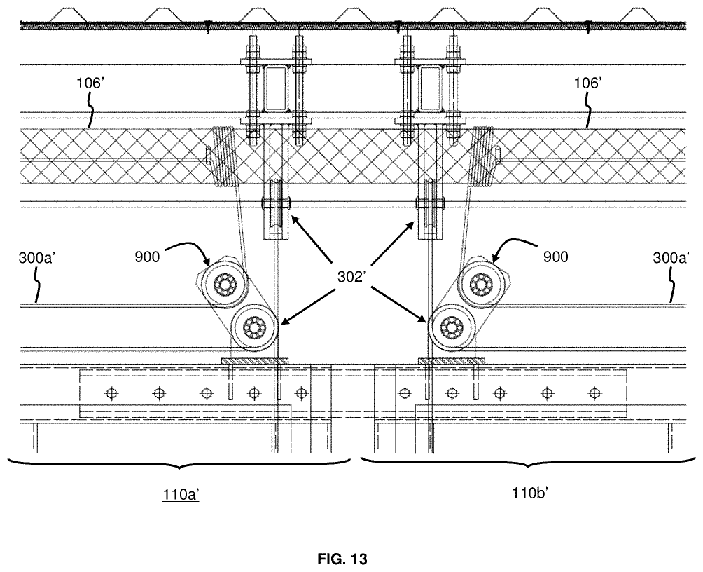

The second flood barrier 800 is different from the first flood barrier 100 in that a counterweight 802 used is in the form of a cage configuration, and has a structure formed from steel and arranged to receive lead counterweight slabs—see FIG. 10, which is an enlarged view of portion A of FIG. 9b. Then, the other difference is that each rotatable drive 106′ is coupled to the panels 110a′, 110b′ via the stainless steel wire ropes 300a′ and a set of steel pulleys 900 (i.e. see FIG. 13 which is an enlarged view of portion B of FIG. 8a).

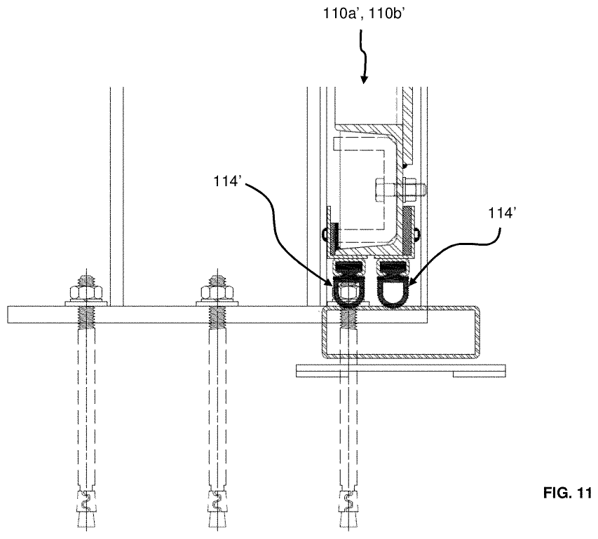

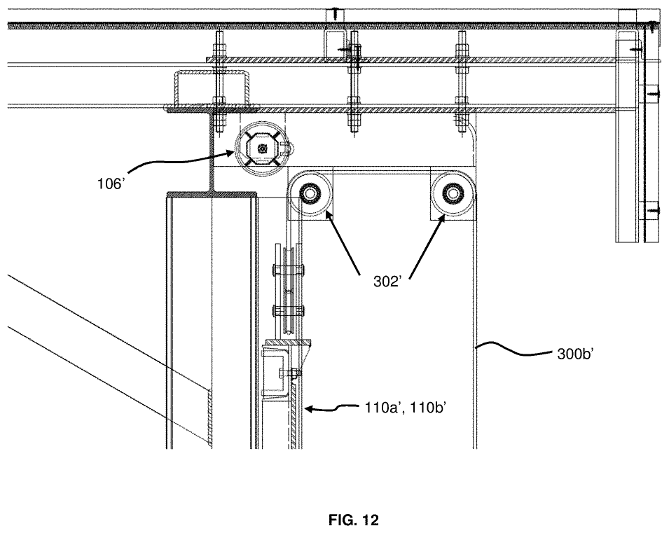

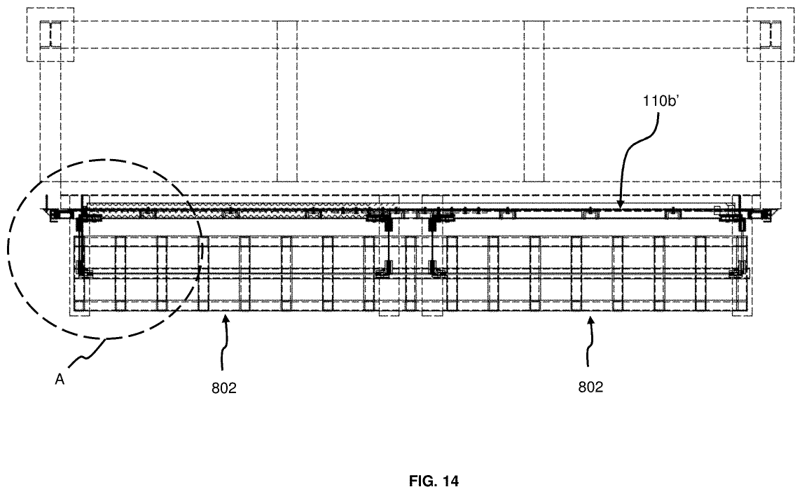

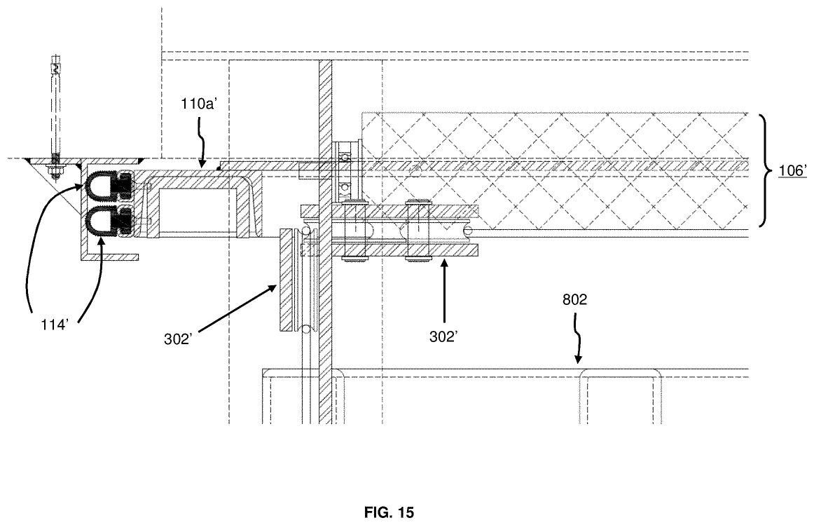

The remaining drawings show the following: FIG. 11 is an enlarged view of portion B of FIG. 9b, FIG. 12 is an enlarged view of portion A of FIG. 8b, FIG. 14 is a top view of the flood barrier of FIG. 8a, and FIG. 15 is an enlarged view of portion A of FIG. 14.

It is to be appreciated that due to global warming, observed glacier meltdown causes sea water levels to rise accordingly. While coastal areas may be raised (e.g. through land reclamation) to guard against the rising sea water levels, the increased sea waters may still be able to ingress to land via rivers and/or canals. So advantageously, the proposed first/second flood barrier 100, 800 is useful for deployment to block the rising sea waters at the mouth of the rivers and/or canals, thereby preventing the sea waters from entering to cause flooding in cities/towns.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

For example, the first/second flood barrier 100, 800 may also be installed across a canal/river to stop inflow of sea water into the canal/river, or to control a level of flood waters in the canal/river to manage/control release of the flood waters into the sea, or to facilitate works within the canal/river to prevent disruptions by upstream flood waters or downstream sea water. In this instance, the member posts 108a, 108b are realisable in the form of stainless steel or reinforced concrete members (for their structural integrity, anti-corrosion and reduced-friction/smoothness properties) to be installed along the width of the canal/river, at where the first/second flood barrier 100, 800 is desired to be deployed. The first/second flood barrier 100, 800, also known as a floodgate, may be housed within purpose constructed steel structure complete with service walkway and roof to facilitate regular maintenance of the first/second flood barrier 100, 800; e.g. see FIG. 9b. Alternatively, the first/second flood barrier 100, 800 may be housed within reinforced concrete structures.

1. A dropdown flood barrier comprising:
at least one panel and an associated counterweight, the panel configured to be movable between an elevated position and a lowered position in cooperation with the counterweight; and
at least one rotatable drive coupled to the panel, and is configured such that rotation of the rotatable drive enables the panel to be moved from the elevated position to the lowered position, the rotatable drive includes a brake arranged to exert a force against the rotation of the rotatable drive when a speed of the rotation exceeds a predetermined threshold,
wherein in use, the rotatable drive is activated to enable the panel to controllably move under its own weight from the elevated position to the lowered position to form a barrier against flood water, the controllable movement of the panel enabled by the brake of the rotatable drive and the counterweight.

2. The flood barrier of claim 1, wherein the panel is arranged intermediate two member posts.

3. The flood barrier of claim 2, wherein the member posts are included as part of the flood barrier, which is to be installed across a canal or a river.

4. The flood barrier of claim 2, wherein the member posts are structural members at an entrance of a building at where the flood barrier is to be installed.

5. The flood barrier of claim 1, wherein the panel further includes a plurality of seals having corrugated surfaces to interface with the member posts to enable the panel to form the barrier against the flood water when in the lowered position.

6. The flood barrier of claim 5, wherein each seal has in a rest condition a generally D- shaped cross-sectional area.

7. The flood barrier of claim 5, wherein each seal is a Thermoplastic-Vulcanizers (TPV) Ethylene-Propylene-Diene-Monomer (EPDM) seal.

8. The flood barrier of claim 7, wherein each seal has an operating temperature range of between −40° C. and 130° C.

9. The flood barrier of claim 5, wherein the plurality of seals are arranged at edges of the panel.

10. The flood barrier of claim 9, wherein at least two layers of seals are arranged at each edge of the panel.

11. The flood barrier of claim 1, wherein the at least one panel includes a plurality of panels configured in a cooperative arrangement to collectively form the flood barrier.

12. The flood barrier of claim 1, wherein the panel is formed from steel structural members.

13. The flood barrier of claim 1, wherein the rotatable drive is coupled to the panel using a plurality of stainless steel wire ropes.

14. The flood barrier of claim 1, wherein the counterweight is formed from steel, and is arranged in a tubular configuration.

15. The flood barrier of claim 1, wherein the counterweight is formed from casted lead ingots, and is arranged in a tubular configuration.

16. The flood barrier of claim 1, wherein the counterweight is formed from steel, and is arranged in a cage configuration.

17. The flood barrier of claim 4, further comprising a threshold plate for positioning at the floor of the entrance to interface with the panel when the panel is in the lowered position.

18. The flood barrier of claim 1, wherein the rotatable drive further comprises at least one electromagnetic lock configured to be electrically activated to inhibit rotation of the rotatable drive to hold the panel in the elevated position, and to be electrically deactivated to permit rotation of the rotatable drive to enable the panel to be moved to the lowered position.

19. The flood barrier of claim 1, wherein the brake includes brake pads arranged to be extendable centrifugally from the main body of the brake to contact against a surface of the rotatable drive for exerting the force, when the speed of the rotation of the rotatable drive exceeds the predetermined threshold.

20. A method of operating a dropdown flood barrier, which includes at least one panel and an associated counterweight, the panel configured to be movable between an elevated position and a lowered position in cooperation with the counterweight, at least one rotatable drive coupled to the panel, and is configured such that rotation of the rotatable drive enables the panel to be moved from the elevated position to the lowered position, the rotatable drive includes a brake arranged to exert a force against the rotation of the rotatable drive when a speed of the rotation exceeds a predetermined threshold, the method comprises:
activating the rotatable drive to enable the panel to controllably move under its own weight from the elevated position to the lowered position to form a barrier against flood water,
wherein the controllable movement of the panel is enabled by the brake of the rotatable drive and the counterweight.
